(19) United States
(12) Patent Application Publication
(10) Pub. No.: US 2013/0298229 A1
(43) Pub. Date: Nov. 7, 2013

(54) ENTERPRISE SECURITY MANAGER REMEDIATOR

(71) Applicants: KRISHNA CHAITANYA MELLACHERUVU, HYDERABAD (IN); SESHU KUMAR AKELLA, HYDERABAD (IN)

(72) Inventors: KRISHNA CHAITANYA MELLACHERUVU, HYDERABAD (IN); SESHU KUMAR AKELLA, HYDERABAD (IN)

(73) Assignee: BANK OF AMERICA CORPORATION, CHARLOTTE, NC (US)

(21) Appl. No.: 13/463,198

(22) Filed: May 3, 2012

(51) Int. Cl. G06F 21/00

(52) U.S. Cl. 726/22

(57) ABSTRACT

Methods, computer readable media, and apparatuses for remediating violations associated with files on one or more servers are disclosed. A violation list including one or more violations associated with one or more files on one or more servers may be received. A type of violation for each of the one or more violations may be determined. A severity may be associated with each of the violations. A fix may be identified for each of the one or more violations and each of the one or more violations may be fixed using the identified fix. The violations may be fixed in order of the associated severity.

### TECHNICAL FIELD

One or more aspects of the disclosure generally relate to computing devices, computing systems, and computer software. In particular, one or more aspects of the disclosure generally relate to computing devices, computing systems, and computer software that may be used by an organization to remediate violations associated with one or more files on one or more servers.

### BACKGROUND

Businesses and organizations may encounter violations associated with their electronic files. The violations may be deviations from baseline values associated with attributes of a file, such as incorrect security levels or incorrect registry values. Currently, each violation must be fixed or remediated individually. If many violations exist within an organization's electronic files, extensive time and resources may be required from the organization's information technology (IT) department to resolve these violations.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In accordance with one aspect of the invention, an apparatus receives a violation list that includes at least one violation corresponding to at least one file on at least one server. The apparatus may identify a type of violation for the at least one file and determine a fix for the at least one violation. Determining a fix for the at least one violation may include identifying a fix from a list of predetermined fixes. Alternatively, determining a fix for the at least one violation may include prompting a request for a fix and in response to prompting a request for a fix, receiving a fix for the at least one violation. The apparatus may fix the at least one violation using the predetermined fix or the received fix. Fixing the at least one violation may include comparing baseline values to attributes of the at least one file and changing the attributes of the at least one file to the baseline values. In one aspect, after fixing the at least one violation, the at least one file is scanned to determine whether the violation was fixed.

Prior to fixing the at least one violation, the attributes of the at least one file may be recorded. Additionally, after fixing the at least one violation, the attributes of the at least one file may be recorded. In at least one embodiment the at least one violation is a security level set higher or lower than a baseline value.

In another aspect, a computing device may receive a violation list including a plurality of violations, wherein each of the plurality of violations corresponds to a file on at least one server. The computing device may identify a type of violation for each of the plurality of violations and determine the severity of each of the plurality of violations. The plurality of violations may then be sorted based on the determined severity of each of the plurality of violations. The computing device may determine a fix for each of the plurality of violations and fix each of the plurality of violations. In at least one aspect, violations having a higher severity are fixed prior to violations having a lesser severity. The determined severity for each of the plurality of violations may be one of a high severity, a medium severity, and a low severity. In one aspect, violations having a determined high severity may be fixed within a first predetermined time, violations having a determined medium severity may be fixed within a second predetermined time, and violations having a determined low severity may be fixed within a third predetermined time. The first predetermined time may be less than the second predetermined time and the second predetermined time may be less than the third predetermined time. Fixing each of the plurality of violations may include comparing baseline values to attributes of each of the plurality of files and changing the attributes of each of the plurality of files to the baseline values. In at least one aspect, each of the plurality of violations corresponds to an incorrect security level of the file.

In another aspect, a violation list including violation plurality of violations corresponding to a plurality of files on at least one server may be received. Receiving a violation list may include scanning a plurality of files on a plurality of servers and generating a list of violations for one or more of the files within the plurality of files. A type of violation may be identified for the plurality of violations and a severity may be determined for each of the plurality of violations. The severity may be based on the type of violation. Identifying the type of violation may include comparing attributes for each of the files associated with each of the plurality of violations to baseline values. The plurality of violations may be sorted based on the determined severity and a fix for each of the plurality of violations, which is based on the type of violation, may be determined. The plurality of violations may be fixed in an order based on the determined severity. Fixing each of the plurality of violations may include comparing baseline values to attributes of each of the plurality of files and changing the attributes of each of the plurality of files to the baseline values.

### BRIEF DESCRIPTION OF THE DRAWINGS

The present disclosure is illustrated by way of example and not limited in the accompanying figures in which like reference numerals indicate similar elements and in which:

FIG. 1A shows an illustrative operating environment in which various aspects of the disclosure may be implemented.

FIG. 1B shows another illustrative operating environment in which various aspects of the disclosure may be implemented.

FIG. 2 shows an illustrative enterprise security manager remediator in accordance with one or more aspects of the disclosure.

FIG. 3 shows an illustrative interface for an enterprise security manager remediator in accordance with one or more aspects of the disclosure.

FIG. 4 shows an illustrative method of remediating violations in accordance with one or more aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized and structural and functional modifications may be made, without departing from the scope of the present disclosure.

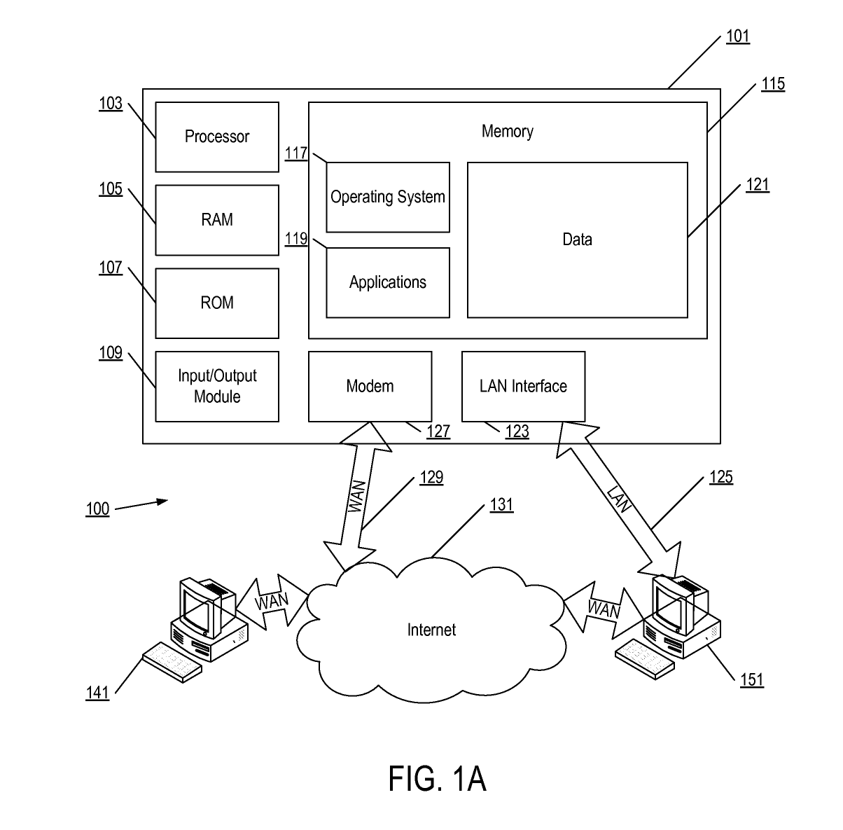

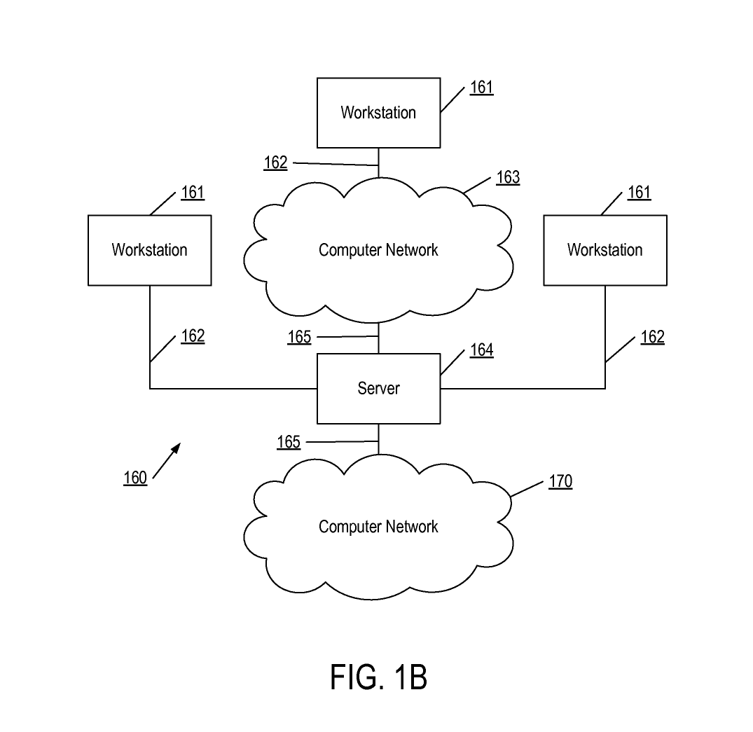

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed. Generic computing device 101 and/or terminals 141 or 151 may also be mobile terminals (e.g., mobile phones, smartphones, PDAs, notebooks, etc.) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a business. Various elements may be located within the business and/or may be located remotely from the business. Such workstations may be used, for example, by employees of the business. Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, etc.

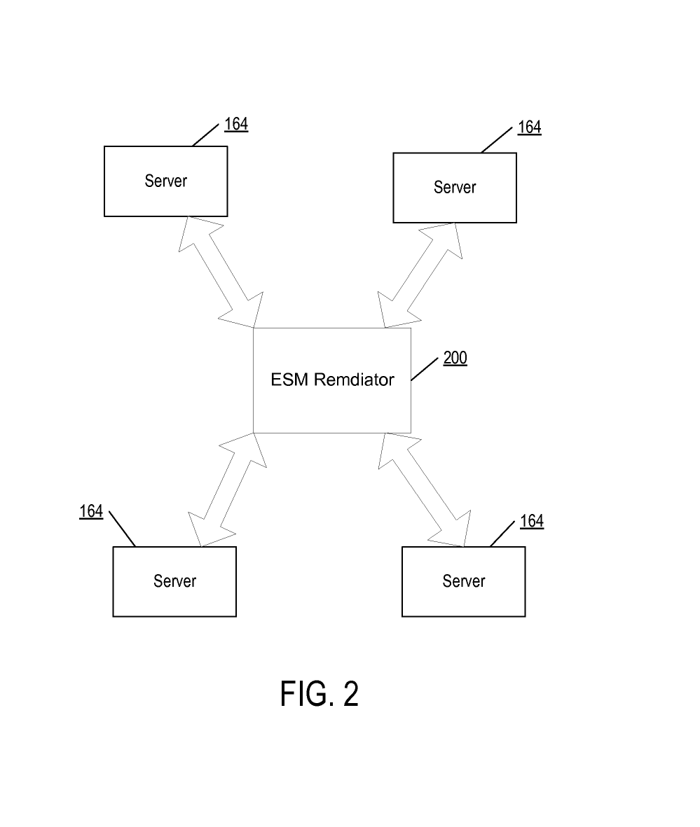

FIG. 2 shows an illustrative enterprise security manager (ESM) remediator 200. The ESM remediator 200 may a computing device, such as computing device 101, depicted in FIG. 1B. The ESM remediator 200 may be associated with a server, such as server 164, depicted in FIG. 1B. As illustrated in FIG. 2, the ESM remediator 200 may communicate with one or more servers, such as servers 164. The ESM remediator 200 may be configured to scan and/or remediate violations associated with one or more files located on the servers 164. The violations may correspond to differences between attributes associated with one or more files and baseline values. For example, a violation may be a security level of a file that is set too high or is set too low. Additionally, a violation may be a discrepancy in a registry value associated with a file or a file that is stored in cache memory that should be stored in uncached memory.

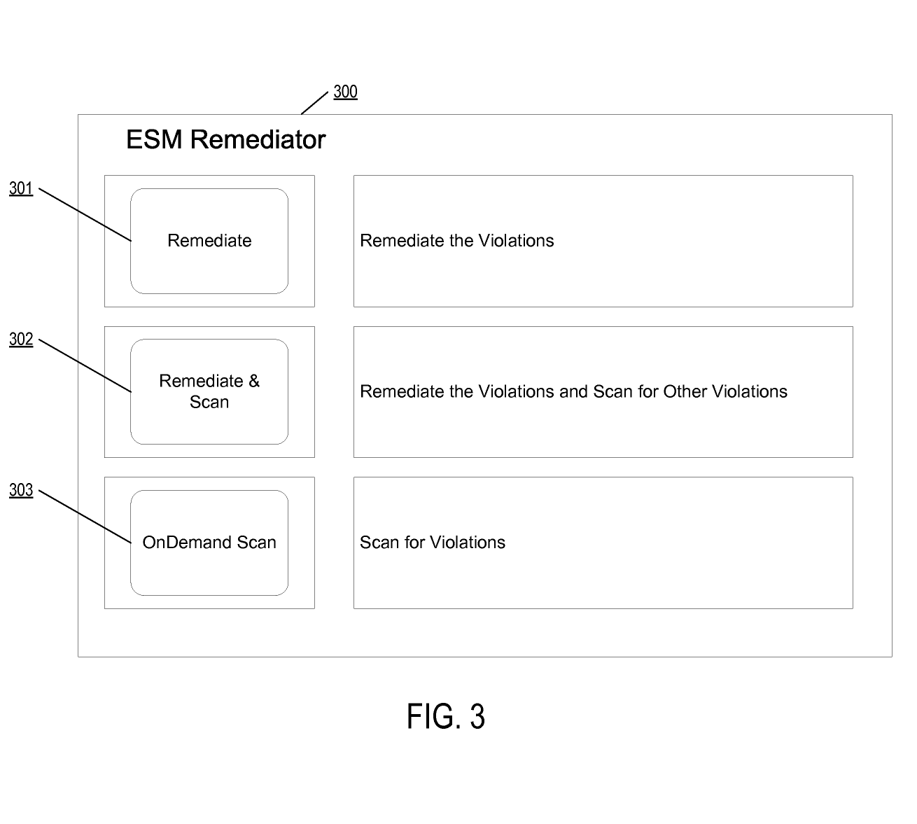

The ESM remediator 200 may include a user interface 300, as illustrated in FIG. 3. The user interface 300 may be web-based or may be included within a software application on the computing device 101. The user interface 300 may include options for operating the ESM remediator 200. For example, the user interface 300 may include option 301 for remediating violations associated with one or more files on the servers 164. Additionally, the user interface 300 may include an option 302 for remediating violations associated with one or more files on the servers 164 and scanning files on one or more servers 164 for additional violations. Further, the user interface 300 may include an option 303 for scanning files on one or more servers 164 for violations.

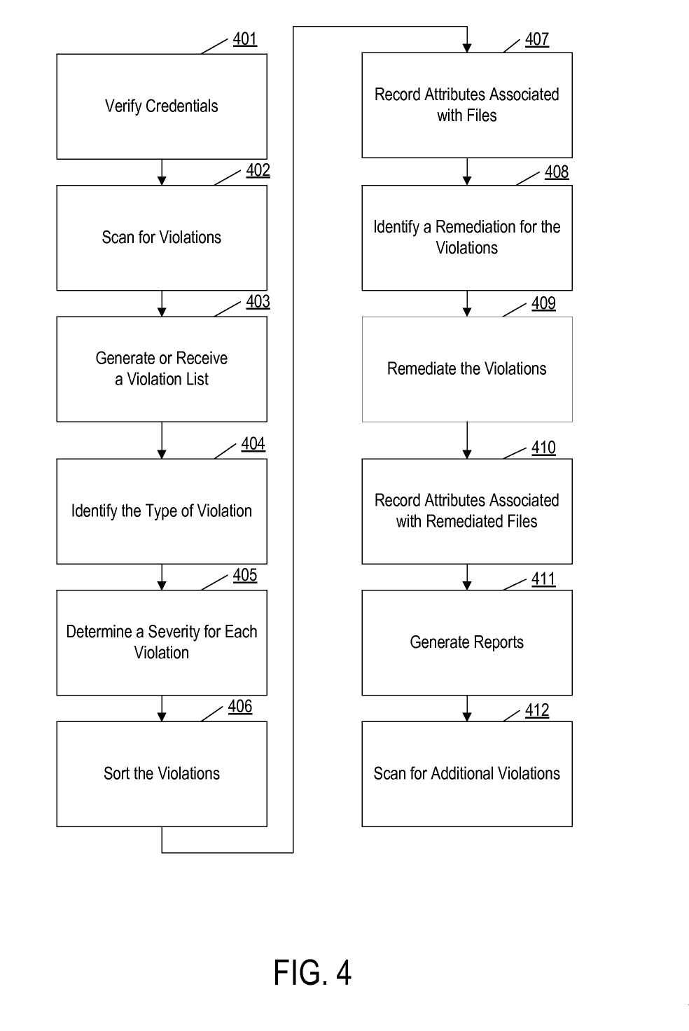

FIG. 4 shows an illustrative method of remediating violations associated with one or more files, according to one or more illustrative aspects described herein. According to one or more aspects, any and/or all of the methods described herein may be implemented by software executed on one or more computers, such as the generic computing device 101 of FIG. 1A, and/or by a computing system, such as system 160 of FIG. 1B. In some arrangements, the methods described herein may be performed by and/or in combination with a server (e.g., server 164). Additionally or alternatively, the methods described herein may be performed by and/or in combination with one or more workstations (e.g., workstations 161).

As illustrated in step 401, a user may be required to log into the ESM remediator 200 and the user's credentials may be verified. In step 402, the ESM remediator may scan one or more files on one or more servers 164 for violations. Any number of files and any number of servers 164 may be scanned by the ESM remediator 200. The ESM remediator 200 may be located on a server 164 that the ESM remediator 200 is scanning. Alternatively or additionally, the ESM remediator 200 may be located remotely from one or more servers 164 of which the ESM remediator 200 is scanning. As illustrated in step 403, the ESM remediator 200 may generate a violation list associated with the scanned files. Alternatively, as also illustrated in step 403, the ESM remediator 200 may receive a violation list from another tool configured to scan files for violations. The violation list may include one or more violations associated with one or more files.

In step 404, a type of violation may be determined for each of the violations in the violation list. The type of violation may be determined by the ESM remediator 200. The type of violation may be any discrepancy associated with a file. As discussed above, the violations may correspond to differences between attributes associated with files and baseline values. For example, a violation may be a security level of a file that is set too high or is set too low. Additionally, a violation may be a discrepancy in a registry value associated with a file or a file that is stored in cache memory that should be stored in uncached memory. To identify the type of violation, the ESM remediator 200 may compare attributes associated with one or more files with baseline values. The baseline values may be values set by the business. In at least one embodiment, the baseline values correspond to the security of the files.

As illustrated in step 405, a severity may be determined and assigned to each violation. The severity may be associated with the impact to the security of the business. In at least one aspect of the invention, severity levels may be assigned to each violation. For example, a violation may be assigned a high severity, a medium severity, or a low severity. Additional levels of severity are contemplated within the scope of the invention.

In step 406, the violations may be sorted by the ESM remediator 200. In at least one embodiment, the violations may be sorted in order of their associated severity. For example, the violations may be sorted such that the highest severity violations are listed before the medium severity violations. The medium severity violations may be listed before the lowest severity violations.

In step 407, attributes associated with the files may be recorded by the ESM remediator 200 to capture the pre-remediation values associated with the files. Step 407 may occur at any time prior to remediation of the violations. In step 408, a fix or remediation for each of the violations may be identified. The fix may be a predefined fix or a fix that is requested and provided on demand. For example, the ESM remediator 200 may include a file or a list containing predetermined fixes for all of the identified types of violations. The fixes may be scripts that are configured to change attributes associated with the files when the scripts are run. If a predefined fix does not exist for a type of violation, the ESM remediator 200 may prompt a user for a fix and once the fix is received, the ESM remediator 200 may use the received fix to remediate the violation. The fixes may be any type of file, such as an Extensible Markup Language (XML) file.

In step 409, the violations may be remediated or fixed by the ESM remediator 200. To remediate the violations, attributes associated with the files may be compared to baseline values and the attributes associated with the files may be changed to the baseline values. The baseline values may be received by the ESM remediator 200 or may be stored within the ESM remediator 200. The fixes may occur by running the identified scripts in step 408. If the attributes associated with the files have been compared to the baseline values in the identification step (step 404), the comparison of the file attributes to the baseline values may be skipped in step 408. In at least one embodiment, the violations are fixed in order of the assigned severity. For example, the violations having the highest severity may be fixed prior to the violations having a medium severity and the violations having a medium severity may be fixed prior to the violations having a low severity.

A predetermined time may be set for fixing violations in each severity group. For example, violations having a high severity may be fixed within a first predetermined time. The predetermined time may be any appropriate time, such as 1 hour, 1 day, 1 week, or the like. Violations having a medium severity may be fixed within a second predetermined time. The second predetermined time may be longer than the first predetermined time. For example, the second predetermined time may be 5 hours, 2 days, 2 weeks, or the like. Violations having a low severity may be fixed within a third predetermined time. The third predetermined time may be longer than the second predetermined time. For example, the third predetermined time may be 24 hours, 1 week, 1 month, or the like. A single file may be remediated at one time or a plurality of files may be remediated at one time, depending on the resources of the ESM remediator 200 and/or associated servers 164.

After the files have been remediated, the ESM remediator 200 may record the attributes of the remediated files, as illustrated in step 410. The recordation in step 410 may be compared with the record or snapshot in step 407 to verify that the fixes for the violations were completed. The records generated in steps 407 and 410 may be used to generate reports as illustrated in step 411. The generated reports may provide details associated with the files, such as the pre-remediated attributes and the post-remediated attributes. Additionally, the reports may show information associated with the types of fixes, the completion of the fixes, the number of violations, and the time it took to remediate each or all of the violations.

In step 412, the ESM remediator 200 may scan for additional violations. The ESM remediator may scan the previously remediated files to determine if the violations were fixed. Alternatively or additionally, the ESM remediator 200 may scan additional files to determine if violations exist.

In at least one embodiment, any interaction of a user with the ESM remediator 200 may be recorded. The user's interactions with the ESM remediator may be used for security purposes and to keep track of the changes each user is making the files within a business.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. An apparatus, comprising:
at least one processor; and
memory storing computer-readable instructions that, when executed by the at least one processor, cause the apparatus to:
receive a violation list including at least one violation corresponding to at least one file on at least one server;
identify a type of violation for the at least one file;
determine a fix for the at least one violation; and
fix the at least one violation using the determined fix, wherein fixing the at least one violation includes comparing baseline values to attributes of the at least one file and changing the attributes of the at least one file to the baseline values.

2. The apparatus of claim 1, wherein the at least one violation corresponds to a caching of at least one file.

3. The apparatus of claim 1, wherein the attributes of the at least one file are registry values.

4. The apparatus of claim 1, wherein the at least one violation is a security level set higher or lower than a baseline value.

5. The apparatus of claim 1, further comprising memory storing computer-readable instructions that, when executed by the at least one processor, further cause the apparatus to:
scan the at least one server to determine whether the at least one violation has been fixed.

6. The apparatus of claim 1, further comprising memory storing computer-readable instructions that, when executed by the at least one processor, further cause the apparatus to:
prior to fixing the at least one violation, record the attributes of the at least one file.

7. The apparatus of claim 6, further comprising memory storing computer-readable instructions that, when executed by the at least one processor, further cause the apparatus to:
after fixing the at least one violation, record the attributes of the at least one file.

8. The apparatus of claim 1, wherein determining a fix for the at least one violation includes identifying a fix from a list of predetermined fixes.

9. The apparatus of claim 1, wherein determining a fix for the at least one violation includes prompting a request for a fix and in response to prompting a request for a fix, receiving a fix for the at least one violation.

10. A method, comprising:
receiving, at a computing device, a violation list including a plurality of violations, wherein each of the plurality of violations corresponds to a file on at least one server;
identifying, by the computing device, a type of violation for each of the plurality of violations;
determining, by the computing device, a severity of each of the plurality of violations;
sorting, by the computing device, each of the plurality of violations based on the determined severity of each of the plurality of violations;
determining, by the computing device, a fix for each of the plurality of violations; and
fixing, by the computing device, each of the plurality of violations, wherein violations having a higher severity are fixed prior to violations having a lesser severity and wherein fixing each of the plurality of violations includes comparing baseline values to attributes of each of the files and changing the attributes each of the files to the baseline values.

11. The method of claim 10, wherein the determined severity for each of the plurality of violations is one of a high severity, a medium severity, or a low severity.

12. The method of claim 11, wherein violations having a determined high severity are fixed within a first predetermined time, wherein violations having a determined medium severity are fixed within a second predetermined time, and wherein violations having a determined low severity are fixed within a third predetermined time.

13. The method of claim 12, wherein the first predetermined time is less than the second predetermined time and the second predetermined time is less than the third predetermined time.

14. The method of claim 10, wherein the list of violations includes a plurality of violations from a plurality of servers.

15. The method of claim 10, wherein at least one of the plurality of violations corresponds to an incorrect security level of the file.

16. The method of claim 10, further comprising:
generating, by the computing device, a report of completed fixes.

17. At least one non-transitory computer-readable medium having computer-executable instructions stored thereon that, when executed, cause at least one computing device to:
receive a violation list including a plurality of violations corresponding to a plurality of files on at least one server;
identify a type of violation for each of the plurality of violations;
determine a severity for each of the plurality of violations based on the identified type of violation;
sort the plurality of violations based on the determined severity;
determine a fix for each of the plurality of violations, wherein the fix for each of the plurality of violations is based on the determined type of violation for each of the plurality of violations; and
fix each of the plurality of violations, wherein each of the plurality of violations are fixed in an order based on the determined severity, wherein fixing each of the plurality of violations includes comparing baseline values to attributes of each of the plurality of files and changing the attributes of each of the plurality of files to the baseline values.

18. The at least one non-transitory computer-readable medium of claim 17, wherein identifying the type of violation for the plurality of violations includes comparing attributes for each of the files associated with each of the plurality of violations to the baseline values.

19. The at least one non-transitory computer-readable medium of claim 17, wherein one or more of the plurality of violations corresponds to a caching of at least one file.

20. The at least one non-transitory computer-readable medium of claim 17, wherein receiving a violation list includes scanning a plurality of files on a plurality of servers and generating a list of violations for one or more of the files within the plurality of files.
